(19) United States
(12) Patent Application Publication
(10) Pub. No.: US 2007/0071998 A1
(43) Pub. Date: Mar. 29, 2007

(54) Preferred copper plated finish and method of making same

(76) Inventor: Vinay Gupta, Minneapolis, MN (US)

Correspondence Address: FONDUNGALLAH KIGHAM & ESSIEN, LLC, 2499 RICE STREET, SUITE 236, SAINT PAUL, MN, 55113, US

(21) Appl. No.: 11/237,131

(22) Filed: Sep. 27, 2005

(51) Int. Cl. B32B 15/20; B05D 3/00

(52) U.S. Cl. 428/674; 428/675; 427/299; 427/372.2

(57) ABSTRACT

A copper plated material having at least a surface that is pretreated, copper plated, heat treated, and having a predetermined color blend incorporated into the surface of the material is provided. The present invention also provides a method of making the copper plated material.

### BACKGROUND

Copper plated materials of various kinds are used in the packaging and container industry. Some copper plated materials serve to protect the interior layer while some coated packages present a look and feel that may present an appealing finish to an otherwise bland package. In other instances, the copper plated materials are used as decorations, trinkets or for other art works. Copper plating typically leaves the surface of the copper plated material with the integral colors of copper. To achieve a desired finish, each copper plated material may be painted or otherwise coated with a desired color. These processes typically add steps to the manufacture process and most often provides the copper plated material with an unstable color. In most cases, the painting process provides a bland color to the copper plated surface.

In some cases, painted surfaces are less desirable due to the chemicals that are used to produce paints. There is a need in the industry to provide a copper plated packaging material that comprises an integral color blend without painting.

Also, there is need to provide a desired color finish to a copper plated packaging material that is typically stable and is not the painted color that may suffer through the fading process known for copper plated painted materials.

From the foregoing, it will be appreciated that what is needed in the art is a low cost, high performance copper plated substrate having a predetermined color blend for use in the packaging industry. Such copper plated surface and methods for preparing the same are disclosed and claimed herein.

### SUMMARY

In one embodiment, the present invention discloses a novel method for preparing a copper plated material comprising the steps of providing a metallic material having at least a surface. The present invention discloses a method wherein the surface of the metallic material is preferably pretreated prior to the copper plating step and preferably heat treated prior to incorporation of a predetermined color blend to provide a metallic material with a surface that is of a predetermined finish.

The present invention also preferably provides a copper plated material made from the above-disclosed method, wherein the copper treated material provides a predetermined finish.

### DETAILED DESCRIPTION

The present invention is directed to a method of making a copper plated packaging material having a unique finish. The present invention preferably provides a method of producing a copper plated packaging material with a desired finish that is usable without painting. The unique surface finish of the copper plated packaging material of the present invention may therefore be painted, laminated and/or decorated if so desired.

In one embodiment of the present invention a color-setting process is preferably incorporated into the copper plating process to provide a packaging material having a desired and unique finish. The application of the color-setting process may be accomplished by a variety of methods. These methods may include introduction of the desired copper plating finish composition into the copper plating solution, by lamination, by brushing, and the like. The method of the present invention preferably includes preparation of the raw material to be copper plated, copper plating and incorporation of the color-setting process.

The copper plated material usable in the present invention may have one or two major opposing sides. Typically, a material used in a copper plating process comprises two major opposing sides. However, it is conceivable that it may be desirable to incorporate copper plating onto only one major side of a packaging material. As used in this disclosure, a packaging material may include sheets of metal, metallic products or panels that may be used as containers, panels (such as coasters, bases, and the like) or protective covers. In some instances, packaging materials of the present invention may be used to craft trinkets, metallic flowers or flowerpots. It is expected that these packaging materials are copper plated and provided with the unique finishes of the present invention prior to such uses.

Suitably, material usable for copper plating is typically metallic, such as tin, zinc, aluminum, copper, blends thereof, and other metallic materials that may now or later be found usable in a copper plating process. In the copper plating process of the present invention, the metallic material is preferably used to provide a copper plated packaging material having a desired and unique finish. Such material useful in the copper plating process of the present invention includes aluminum, zinc, copper, or composites thereof. For the present invention, aluminum is preferred. The aluminum used in the preferred embodiment should preferably be of such thickness as to withstand the thermal and chemical process of copper plating. It is preferably about at least 0.0015 inches (0.038 mm) thick, more preferably between about 0.0015 and 0.0050 inches (0.038 and 0.127 mm) and most preferably between about 0.0015 and 0.0030 inches (0.038 and 0.076 mm).

The preparation of the material for copper plating according to the present invention preferably includes a pre-treatment or phosphating and polishing process.

The pre-treatment process of the present invention preferably includes steps to remove impurities on the material, such as degreasing, de-rusting, phosphating and may include passivation. Each of these steps may be taken singly or in any combination to provide a surface treated and usable in subsequent steps of the copper plating process.

In one embodiment of the present invention, the metallic material used in the copper plating process degreased in any solution suitable to achieve the intended purpose. In the preferred embodiment, the degreasing process is accomplished with the use of a degreaser. Typical degreasers are selected from chemical blends or compositions suitably used for degreasing of metallic surfaces as is known in the art. It is also conceivable to utilize gas-enabled degreasers, or equipments aided by forced air or sprayers to remove impurities from the surface of the material prior to the next step in copper plating. In some instances, etching chemicals or solutions that are typically used in etching and degreasing process may be incorporated. For example, these chemicals may include solutions of sodium hydroxide (NaOH), sodium carbonate (Na₂CO₃), trisodium phosphate (Na₃PO₄), sodium lauryl sulphate (CH₃(CH₂)₁₁OSO₃Na), or blends thereof. A preferred degreaser concentration usable in the present invention is between about 10 and 40 weight percent, more preferably between about 15 and 35 weight percent, and most preferably between about 20 and 30 weight percent of degreaser in solution. A preferred temperature of the solution is between about 50 and 90° C., more preferably between about 60 and 85° C., and most preferably between about 70 and 80° C. A preferred degreasing process may be accomplished in about 30 minutes, more preferably between about 1 and 20 minutes, and most preferably between about 5 and 15 minutes. Notwithstanding the ranges and conditions detailed above, the primary goal of the degreasing process, or etching when desired, is to remove the grease and/or impurities from the surface of the material to be copper plated. Any process to achieve such grease and impurities removal is incorporated in this disclosure.

In some instances, a de-rusting process is incorporated to prepare the surface of the material for copper plating. Such process includes the use of, preferably acids to remove rust or corrosion from the surface of the material. Typical acids used in the derusting process include phosphoric acid blend such as GARDACID® 2061 available form Chemetall PLC, of Bletchley, Milton Keyes, Britain and RustoClean-AV series of de-rusting chemicals available from Aarvee chemicals, Bangalore 560020, India. Preferably, the concentration of the acid used in de-rusting is between about 2 and 20 weight or volume percent of acid to water, more preferably between about 5 and 18 weight or volume percent, and most preferably between about 8 and 15 weight or volume percent. The preferred acid temperature is between about 50 and 90° C., more preferably between about 60 and 85° C., and most preferably between about 70 and 80° C. A preferred de-rusting process may be accomplished in about 30 minutes, more preferably between about 1 and 20 minutes, and most preferably between about 5 and 15 minutes.

After degreasing and, if necessary, de-rusting, the surface of the material may need to be phosphated prior to copper plating. As used in this disclosure, phosphating denotes a process wherein a surface of the material is protected from corrosion and made more adherent for the plating process. Phosphating provides a preferred coating base for the surface of the material for copper plating according to the present invention. Typical chemical formulations used in phosphating include phosphoric acid (H₃PO₄), zinc oxide (ZnO), nitric acid (HNO₃), and blends thereof. In this invention, a zinc phosphating solution available under the name GARDOBOND® 2004 at a preferred concentration of between about 2 and 10 percent, more preferably between about 2 and 8 percent, and most preferably between about 2 and 6 percent is used. If unstated, all chemicals used in this disclosure are readily available from ChemCentral of Bedford Park, Ill.; Chemetall PLC, Bletchley, Milton Keyes, Britain; or Aarvee Chemicals, Bangalore 560020, India. The preferred temperature for phosphating according to the present invention is between about 50 and 90° C., more preferably between about 60 and 85° C., and most preferably between about 70 and 80° C. Phosphating, according to the present invention may preferably be accomplished in about 30 minutes, more preferably between about 1 and 20 minutes, and most preferably between about 5 and 15 minutes.

In the present embodiment or when needed, a passivation process may be incorporated prior to copper plating. As used herein, passivation denotes the removal of exogenous iron or iron compounds from the surface of the material by means of a chemical dissolution, most typically by a treatment with an acid solution that will remove the surface contamination, but will not significantly affect the material itself. It may include the chemical treatment of material surface steel with a mild oxidant, such as a nitric acid solution, for the purpose of enhancing the formation of the protective passive film. Any chemical formulation known and used in the art may be utilized in the passivation process. In the present invention, GARDOLENE-1, a blend of phosphoric acid (H₃PO₄) and chromic acid (CrO₃) is preferred at a concentration of at least about 0.1 milliliter per liter, more preferably at least about 0.2 milliliter per liter of solution. Typically, the preferred temperature of operation is between about 50 and 90° C., more preferably between about 60 and 85° C., and most preferably between about 70 and 80° C. Passivation, according to the present invention may preferably be accomplished in about 30 seconds, more preferably between about 1 and 20 seconds, and most preferably between about 5 and 15 seconds.

Suitably, at the completion of each of the above steps in the process, the surface of the material may preferably be rinsed with deionized water. Each of the stated steps may be accomplished in a vat, trough, or other suitable containers for the process. It is conceivable that these steps may be incorporated in sequence or in a mechanized process or processes as are obtainable in commercial operations. A cleaning step such as wire brushing or pad finishing may be incorporated to ensure surface readiness for copper plating.

The material prepared from the above-discussed processes steps or combinations thereof may then be copper plated. Copper plating may be accomplished by any means known in the art. The copper plating process may be electrolytic, electroless, or any other process as is known in the art. It is conceivable that a variety of chemicals may be incorporated to obtain a desired copper plated product. Variations of the process for different materials are also conceivable. In the present invention, the material is preferably plated with a cuprous cyanide (CNCu) solution, which may also comprise sodium cyanide (NaCN) and sodium carbonate (Na₂CO₃), such as COPCYN-150 available from Chemetall, PLC. The cuprous cyanide (CNCu) solution used in the present invention is preferably at a concentration of between about 70 and 200 grams per liter, more preferably between about 80 and 180 grams per liter, and most preferably between about 100 and 150 grams per liter. The density of the solution is preferably between about 10 and 40° Be, more preferably between about 15 and 30° Be, and most preferably between about 20 and 25° Be. Typical solution temperature range for the copper plating process is between about 20 and 70° C., more preferably between about 30 and 60° C., and most preferably between about 40 and 50° C. Voltage requirements vary for copper plating processes and depend on equipment used, number of plates to be plated, among other factors. In the instant invention, voltage for the process is preferably between about 10 and 20 volts, more preferably between about 12 and 18 volts, and most preferably between about 14 and 17 volts. Copper plating in the present invention may preferably be accomplished in about 1 to 30 minutes, more preferably between about 1 to 20 minutes, and most preferably between about 5 and 15 minutes.

After the initial copper plating, the plated material is preferably powder-rubbed. Powder rubbing includes physical rubbing the surface (preferably by hand) of the material with or without the use of chock powder, such as calcium-based powders commonly available in the marketplace. Upon completion of the powder rubbing process, the copper plated material is also preferably water rinsed with deionized water. Rinsing may be accomplished by spraying off excess powder on the surface copper plated material.

Another step in the embodiment of the present invention is nickel plating. As with copper plating, nickel plating may be accomplished by any process known in the art. In the present embodiment, a chemical formulation is incorporated in the nickel-plating process; the formulation being a composition comprising nickel sulphate, nickel chloride and boric acid. The concentrations of the chemicals may vary depending on the desired result. In the present invention, Nickel Sulphate (NiSO₄) is preferably at a concentration of between about 100 and 200 grams per liter, more preferably between about 120 and 180 grams per liter, and most preferably between about 140 and 160 grams per liter. Nickel Chloride (NiCl₂) is preferably between about 10 and 80 grams per liter, more preferably between about 20 and 70 grams per liter, and most preferably between about 30 and 60 grams per liter. Boric acid (H₃BO₃) is preferably between about 10 and 80 grams per liter, more preferably between about 20 and 70 grams per liter, and most preferably between about 30 and 60 grams per liter.

The density of the nickel plating solution is preferably between about 10 and 40° Be, more preferably between about 10 and 35° Be, and most preferably between about 15 and 25° Be. Typical solution temperature range for the nickel-plating process is between about 20 and 70° C., more preferably between about 30 and 60° C., and most preferably between about 40 and 50° C. Voltage requirements vary for copper plating processes and depend on equipment used, number of plates to be plated, among other factors. In the instant invention, voltage for the process is preferably between about 10 and 20 volts, more preferably between about 12 and 18 volts, and most preferably between about 14 and 17 volts. Nickel-plating in the present invention may preferably be accomplished in about 1 to 30 minutes, more preferably between about 1 to 20 minutes, and most preferably between about 5 and 15 minutes. Preferably, the nickel-plating solution has a pH of between about 4.0 and 6.0, more preferably between about 4.0 and 5.5, and most preferably between about 4.5 and 5.0.

After nickel-plating, and preferably a water rinse with deionized water, the material of the present invention is then copper plated. The preferred second copper plating process in a similar process as discussed above, utilizes the same cuprous cyanide solution except for the duration of the process. For this step in the present invention, the copper plating is accomplished in preferably between about 10 to 50 minutes, more preferably between about 15 to 40 minutes, and most preferably between about 20 and 30 minutes.

As discussed above, the present invention provides a copper plated material that has a unique and desired finish without the added process of painting or otherwise incorporating a color in a secondary process step. In a typical process, such finish may be accomplished by subjecting the plated material to a spray-on, brush or similar process. The present invention incorporates a predetermined blend to provide the desired and unique finish to the copper plated material.

The unique finish of the present invention is provided by processing the material as part of the copper plating process through a copper nitrate (Cu(NO3)₂) solution. In this embodiment, the copper plated material is preferably introduced into a heated environment such as an oven prior to dipping in the copper nitrate solution. The temperature of the oven is preferably between about 160 and 300° C., more preferably between about 180 and 280° C., and most preferably between about 200 and 260° C. A preferred residence time in the oven may be between about 2 and 20 minutes, more preferably between about 2 and 15 minutes, and most preferably between about 4 and 12 minutes. Dipping in the copper nitrate solution may be accomplished by any means known in the art. Preferably, the heated copper plated material is dipped and retrieved from the solution in about as long as it takes to submerge all the copper plated material in the solution. If needed, the dipped material is allowed to dry in air or through a forced-air equipment.

Depending on the desired finish, a subsequent dipping process may be incorporated in the present invention to provide a unique finish to the copper plated material. As an example, colors may be incorporated to provide a desired finish. In an embodiment of the present invention, and as an example, without limitation to a single color, a blend of colors, such as yellow and orange may be incorporated into the desired finish. In a preferred embodiment, orange and yellow color concentrates in the ratios of about at least 2 parts orange and 1 part yellow may be used to create a solution blend for the subsequent dipping process. A solution blend preferably comprising between about 10 and 35 grams per liter of the colors may be used. More preferably, the blend may comprise between about 15 and 30 grams per liter, and most preferably between about 15 and 25 grams per liter of the color concentrates. The copper nitrate dipped material may then be dipped in the color blend solution for as long as needed to fully cover the material to be dipped. Drying of the dipped material may be accomplished by air-drying or through any means known in the art to accomplish such drying without causing blisters or other undesired aesthetic defects.

Typically, copper plated materials may be provided with a protective clear coat to provide protection from scratches, weather resistance and/or discoloration. In an embodiment of the present invention, a blend of epoxy clear (a composition of about 80 percent polyester and about 20 percent epoxy resin) in a concentration sufficient to provide 1 kilogram (2.2 pounds) of powder per square feet (0.093 square meters) is preferably applied onto the plated and dipped material. The application may be accomplished by any means known in the art such as powder spraying, coating, painting, and the like. The coated product is then baked in an oven for at least 15 minutes preferably at a temperature of between about 150 and 250° C., more preferably between about 160 and 230° C., and most preferably between about 170 and 220° C.

Upon completion of the above processes or a selection thereof, the finished and material is then preferably available for forming into shapes according to intended uses.

Having thus described the preferred embodiments of the present invention, those of skill in the art will readily appreciate that the teachings found herein may be applied to yet other embodiments.

What is claimed is:

1. A method of providing a copper plated material, comprising the steps of:
providing a metallic material having at least a surface;
pre-treating the at least a surface of the metallic material;
copper plating the surface of the metallic material;
heat treating the surface of the metallic material;
incorporating a predetermined color blend onto the surface of the metallic material, wherein the copper plated material presents a predetermined finish that is usable without painting.

2. The method of claim 1, wherein the metallic material has a first and a second surface.

3. The method of claim 2, wherein the first and second surfaces of the metallic material are copper plated and have the predetermined finish.

4. The method of claim 1, wherein the pre-treatment of the metallic material includes degreasing, de-rusting, phosphating, passivating, or combinations thereof.

5. The method of claim 1, wherein the copper plating process includes a first copper plating, nickel plating and a second copper plating of the metallic material surface.

6. The method of claim 1, wherein the heat treating of the metallic surface includes a dipping process in a cuprous nitrate solution.

7. The method of claim 1, wherein the predetermined color blend is yellow-orange.

8. The method of claim 7, wherein the predetermined color blend is made from concentrates comprising two parts orange and one part yellow.

9. The method of claim 1, wherein the metallic material surface is clear coated.

10. A copper plated material comprising:
at least a first metallic surface that is pretreated, copper plated, heat treated and color treated, wherein the surface of the metallic material provides a desired finish.

11. The copper plated material of claim 10, wherein the material comprises at a first and a second surface.

12. The copper plated material of claim 11, wherein the first and second surfaces have the desired finish.

13. The copper plated material of claim 10, wherein the pretreatment includes degreasing, derusting, phosphating, passivating, or combinations thereof.

14. The copper plated material of claim 10, wherein the copper plating process includes a first copper plating process, nickel plating and a second copper plating process on the metallic surface.

15. The copper plated material of claim 10, wherein the metallic surface is heat treated and dipped in a cuprous nitrate solution.

16. The copper plated material of claim 10, wherein the predetermined finish is a yellow-orange color blend.

17. The copper plated material of claim 16, wherein the predetermined finish is made from concentrates comprising two parts orange and one part yellow.
